(19) United States
(12) Patent Application Publication
(10) Pub. No.: US 2013/0148341 A1
(43) Pub. Date: Jun. 13, 2013

(54) HEATSINK FOR LIGHTING DEVICE

(71) Applicant: Nicolas Paul Williams, Knighton (GB)

(72) Inventor: Nicolas Paul Williams, Knighton (GB)

(73) Assignee: LITONICS LIMITED, Knighton, Powys (GB)

(21) Appl. No.: 13/818,639

(22) PCT Filed: Aug. 19, 2011
(86) PCT No.: PCT/GB11/51571

§ 371 Date: Feb. 22, 2013

(30) Foreign Application Priority Data
Aug. 23, 2010 (GB) 1014056.4
Aug. 31, 2010 (GB) 1014428.5

(51) Int. Cl. F21V 29/00; F21L 4/02

(52) U.S. Cl. CPC F21V 29/22; F21L 4/02
USPC 362/184; 29/592.1

(57) ABSTRACT

A thermally conductive heatsink is for cooling a plurality of light emitters within a lamp, luminaire, lighting device or ancillary apparatus thereof, the heatsink having one or more holes, recesses, compartments, chambers or internal cavities for locating one or more cells, batteries or other charge storage devices able to provide power to electronic control circuitry and or light source(s). The internal cavities may additionally provide space to fully or partially locate electronic circuitry or electrical components. Conjointly to thermal operation, the heatsink may act as a chassis or holder for one or more components of the lamp, luminaire or lighting device. The cooling elements can be of any size, design or material, and the heatsink can have one or more parts each of any shape, design, construction or material.

### BACKGROUND

The present invention relates to a heatsink for a lighting device and to a lighting device having that heatsink. The invention has particular although not exclusive relevance to LED light bulbs containing internal circuitry, electrical components and/or one or more cells or batteries, wherein cooling of the light emitting device or devices is required for efficient operation, and minimal available space requires efficient juxtaposition of system components.

The present inventor has previously proposed, in his GB patent number 2447495, an electric lighting device having circuitry that can detect mains failure and which can provide power to the lighting device from a back-up battery provided in or close to the lighting device. The present invention has been made as a result of the inventor trying to improve upon the original design proposed in his earlier GB patent.

### SUMMARY OF INVENTION

According to one aspect, the invention provides a lighting device comprising: a heatsink and one or more light sources mounted on an outer surface of the heatsink, wherein the heatsink comprises one or more internal cavities; first electrical connections for receiving power from an external supply; second electrical connections mounted within the cavity of the heatsink for receiving power from a battery that can be mounted within the cavity; and circuitry for controlling power delivery to the one or more light sources using power from at least one of the battery and the external supply. The lighting device may be sold together with the battery mounted in the cavity or the battery may be inserted or replaced later.

Typically, the heatsink comprises a thermally conductive material, with an outer surface of the heatsink on which the one or more light sources can be mounted. The heatsink material may be electrically non-conductive so as to provide electrical isolation between the inside wall of the cavity and the outer surface of the heatsink. Additionally or alternatively the heatsink material could be electrically conductive and a layer of electrically isolative material may be used to line the inside walls of the heatsink and/or other heatsink parts which may be in proximity to mains voltages, or the external surfaces of said heatsink.

A thermally non-conductive material may also be provided between the inside wall of the cavity and any electronic or electrical component mounted in the cavity. This material may be formed as a layer attached to the cavity wall or as loose fitting material that sits between the enclosed device and the cavity wall. Alternatively, electric isolation may be achieved by providing an air gap between the inside wall of the heatsink and an electrical device provided therein.

In a preferred embodiment the heatsink comprises an elongate portion in which one or more of the cavities are provided. Such an elongate portion is preferred as it provides a relatively long surface area over which many light emitting devices can be mounted. The outer surface of the heatsink may be smooth or multi-faceted. Where it is multi-faceted, one or more light sources may be mounted on at least some of those facets.

In one embodiment, the heatsink has a base portion with one or more cooling devices, such as cooling fins. The base may in addition or alternatively have a groove into which a transparent or translucent cover can be fitted enclosing the portions of the heatsink carrying the one or more light sources.

The heatsink may be mounted internally or externally of a light bulb enclosure or other luminaries or ancillary lighting devices or equipment. The enclosure or cover is preferably translucent or transparent that encases the light source(s). In one embodiment, the cover encases an elongate portion of the heatsink comprising the cavity and sits within a groove provided on a base of the heatsink. The enclosure may be bulb shaped or tubular.

The one or more light sources may comprise one or more Light Emitting Diodes (LEDs), Organic LEDs, or other heat-producing light emitting devices. It is important for this type of light emitting device to remove the heat produced to increase efficiency and life span of the lighting device. The LEDs are preferably arranged on a number of facets of the heatsink, such as to provide illumination over a wide area. The LEDs may be attached to each facet in a linear or 2-dimensional array.

The lighting device may be provided with a fan to blow or draw air over the heatsink to promote the cooling of the light source(s).

In one embodiment, the lighting device comprises electronic circuitry configured to distinguish between removal of a mains supply to the lighting device by a user opening a switch coupled, in use, to the lighting device and mains failure; and, upon detection of mains failure, configured to connect a charge storage device to the light sources to provide emergency lighting functionality.

The lighting device may be, in one embodiment, an in-line adapter having a connector for connecting to a light fitting and an adapter for receiving a light bulb or other lighting device.

The heatsink may also be electrically conductive and electrically connected to circuitry of the lighting device. The circuitry may comprise communications circuitry for communicating with a remote device and wherein the heatsink is arranged to act as an antenna for the communications circuitry. The communications circuitry may receive commands from the remote device and may control the light generated by the lighting device in dependence upon the received commands. The circuitry may be mounted within a cavity of the heatsink.

Another aspect provides a method of making a lighting device comprising the steps of: providing a heatsink having an internal cavity; mounting one or more light sources on an outer surface of the heatsink; providing electrical connections for receiving power from an external supply; mounting a battery within the cavity of the heatsink; and providing circuitry for controlling power delivery to the one or more light sources using power from at least one of the battery and the external supply.

The invention also provides a heatsink for thermally cooling one or more light sources of a lamp, wherein the heatsink comprises one or more internal cavities for housing a battery used to provide power to the light sources.

These and other aspects of the invention will become apparent from the following description of exemplary embodiments which will be described with reference to the following drawings (not to scale) in which:

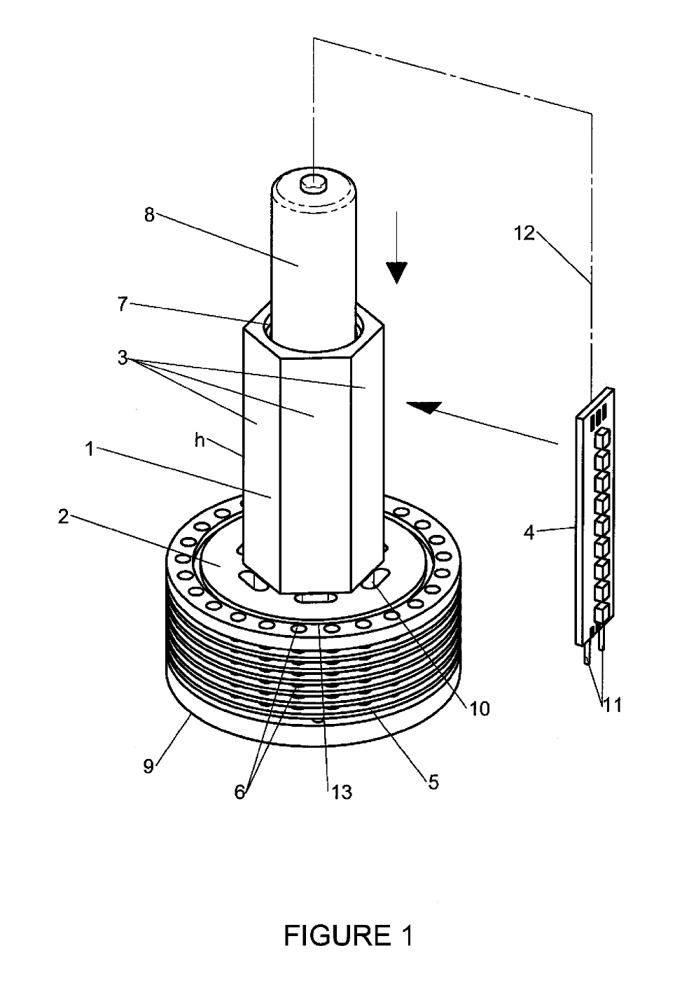

FIG. 1 is a perspective view of one embodiment of a light source heatsink having multiple surfaces for attachment of light emitters and featuring one or more internal cavities for housing one or more cells or batteries and/or other electronic components therein;

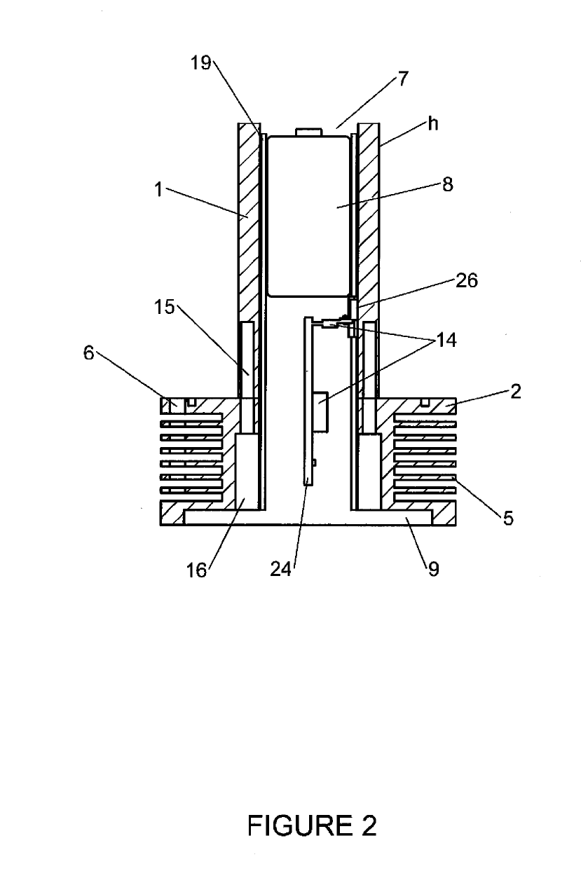

FIG. 2 is a cross sectional view of the heatsink shown in FIG. 1 illustrating that the heatsink is constructed in at least two parts that are mechanically joined together and illustrating the positioning of a battery within an internal cavity of one of the parts;

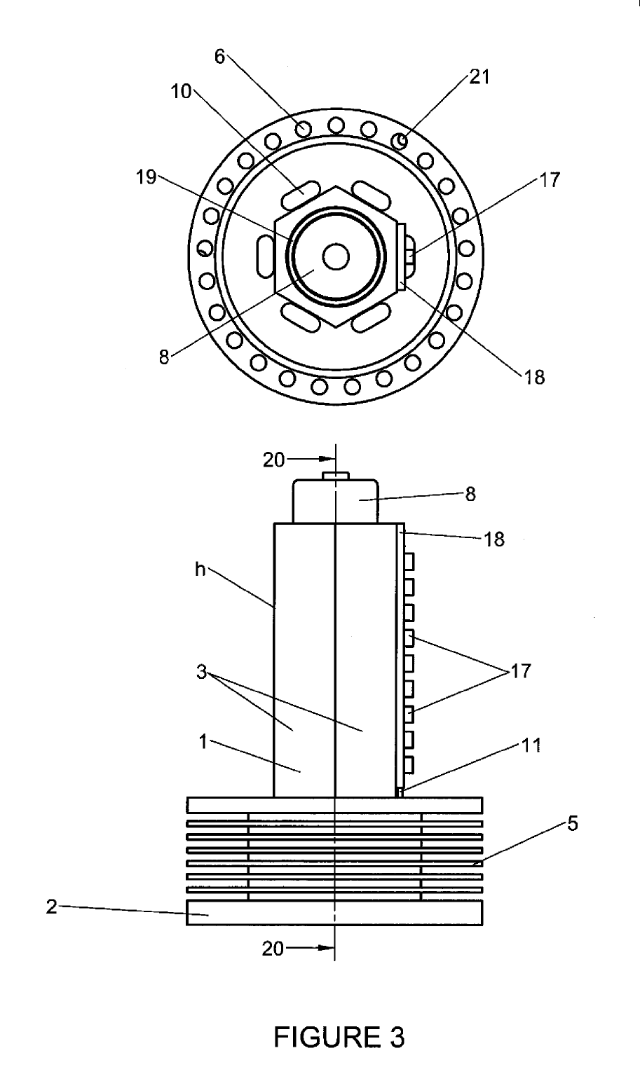

FIG. 3 shows an end cross sectional view of the heatsink shown in FIG. 1 together with a side view of the heatsink, the end cross sectional view showing an electrically and thermally isolative layer between the internal wall of the heatsink that defines the cavity and the internal component, in this case the battery;

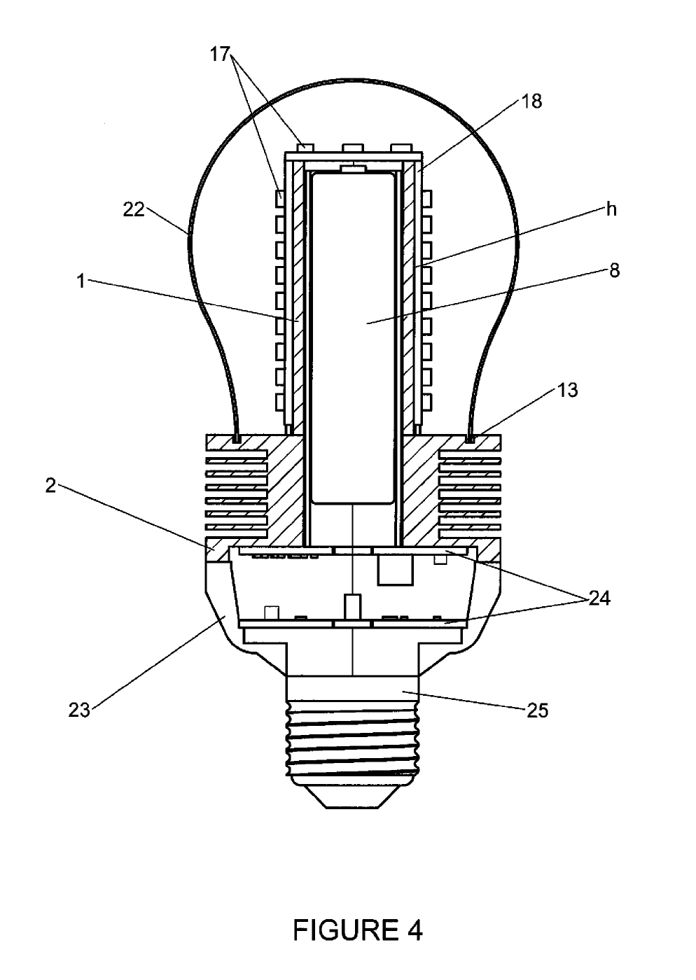

FIG. 4 schematically illustrates how the heatsink shown in FIGS. 1 to 3 can be used in a typical light bulb enclosure and illustrating its use with a plurality of LED emitters able to provide a light source from mains and/or battery power;

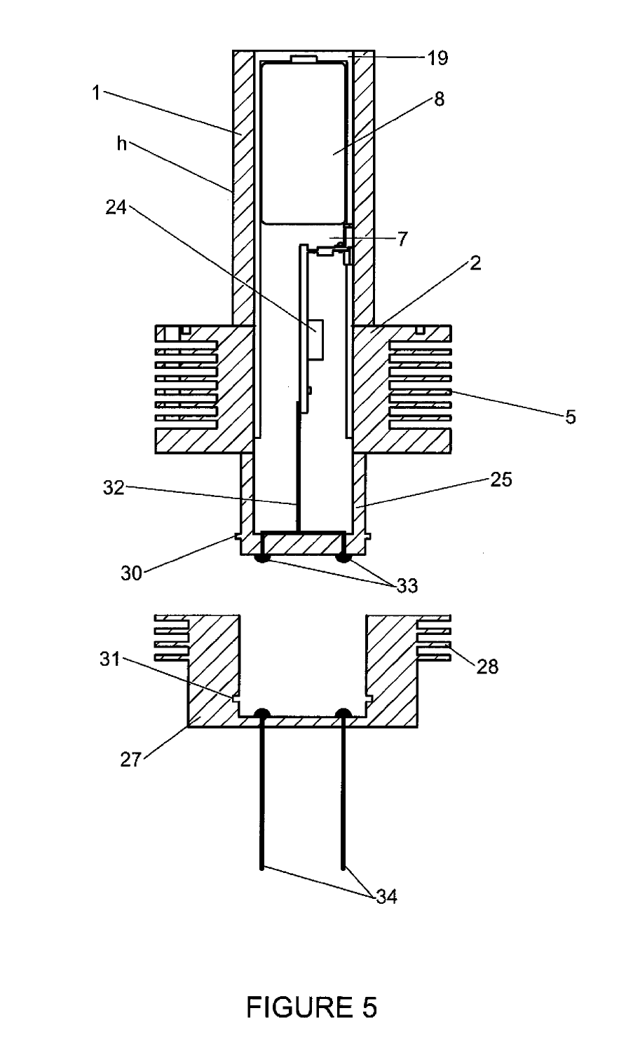

FIG. 5 shows one embodiment where the heatsink of FIG. 1 is thermally connected to an external fitting cap for providing either primary or supplementary cooling through the holder, this holder may additionally provide the mechanical and electrical connection, as illustrated in this example; and

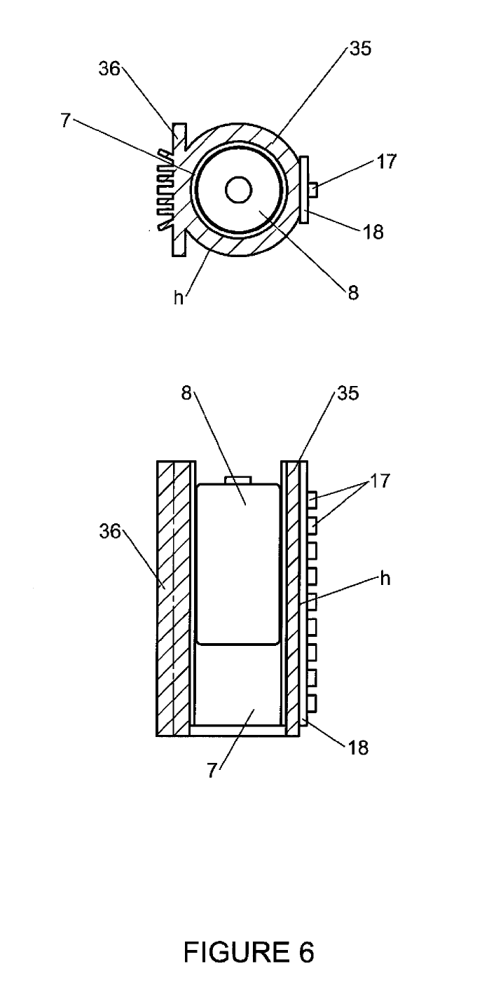

FIG. 6 illustrates how the heatsink may be mounted within a typical light tube enclosure with a plurality of LED emitters or other light sources.

### DETAILED DESCRIPTION

FIG. 1 shows a heatsink (labelled h) according to one embodiment of the present invention. The heatsink h comprises, in this embodiment, an elongate tower 1 and a base 2, of any thermally conductive material or materials (such as aluminium or other alloys, composites, or ceramics which may have improved electrical isolation properties). In this embodiment, the tower 1 and the base 2 are each separate monolithic structures, in other embodiments they may be formed from multiple components or they may be formed as a single monolithic structure. The purpose of the heatsink h is to absorb heat away from the outer surface or surfaces 3 of the tower 1 on to which one or more light sources 4 will be directly or indirectly attached. The light sources 4 may be LEDs or any other heat-generating light emitter technology, mounted individually or in arrays such as in linear strips as illustrated in FIG. 1. In this embodiment, the tower 1 is tubular and preferably has a multi-faceted outer surface (although it could have a circular cross section if desired). In this embodiment, the tower 1 has six outer faces 3 that permit for attaching light sources 4.

Heat is conducted away from the outer surfaces 3 of the tower 1 through base 2 and radiated, convected, or otherwise dispersed at cooling fins 5, which may be of any number, design, size or shape with the preferred aim of maximising surface area. These cooling fins 5 may include a plurality of holes 6 to assist in cooling by air convection, particularly when the heatsink is in the vertical orientation either as shown in FIG. 1 or when rotated 180 degrees to that shown in FIG. 1.

One of the important and advantageous design features of the heatsink h of this embodiment is that within the tower section 1 there exists at least one internal cavity (hole, recess, compartment or chamber) 7 that partially or fully extends through the tower 1 and base 2 of the heatsink h. As illustrated in FIG. 1, in this embodiment, a cell or battery or any other electrical storage device 8 capable of providing electrical power to the light source(s) 4, is provided within the cavity 7. The same cavity 7 or another cavity 9 may be accessible at the lower end of the heatsink h for gaining access to the connection(s) to the battery 8.

As will be described below, in this embodiment, the lower part of cavity 7 also houses electronic circuitry which may also be powered by the battery 8 and which is also accessible from underneath the base 2.

One or more holes 10 may be provided through base 2 to allow electrical connections 11 to be made between the battery 8 and the light source(s) 4. Additionally or alternatively, electrical connections 12 to the battery 8 or the electronic circuitry may be made via a mounting PCB holding the light sources 4.

An additional feature of the heatsink h of this embodiment is that it includes a groove 13 in the top of the base 2 that permits convenient attachment of a light transparent, translucent or dispersing globe, cap or housing such that the heatsink h thereby forms the main chassis or supporting mechanical member of an electric lamp emulating a traditional incandescent light bulb (as illustrated in FIG. 4 described further below).

FIG. 2 is a cross sectional view longitudinally through the heatsink h shown in FIG. 1. FIG. 2 illustrates the functional position of the battery 8 inside the cavity 7 of the heatsink h. As shown in FIG. 2, in this embodiment, electronic circuitry 14 is mounted in a lower part of the cavity 7 beneath the battery 8. The electronic circuitry 14 is preferably mechanically and/or thermally connected to the inner wall of the base 2 of the heatsink h (which in this embodiment is lined with an electrical insulating layer 19). In this embodiment illustrated in FIG. 2, one or more printed circuit boards 24 hold the electronic circuitry 14, with a mechanical and thermal connection 26 being made between of one of these boards 24 and the internal surface of the cavity 7. As those skilled in the art will appreciate, the electronic circuitry does not have to be mounted within the same cavity 7 as the battery 8—it may be mounted within a separate cavity if desired.

The battery 8 may additionally be cooled by the heatsink h through conduction via the internal walls of the cavity 7 as part of its own operation, depending upon the cell or battery technology employed.

FIG. 2 also shows that, in this embodiment, the tower 1 is coupled to the base 2 via bolts 15 through holes 16, although this is solely by way of example, and the heatsink can be constructed in any manor from one or more parts or extrusions.

FIG. 3 shows a similar embodiment with previously described features including tower 1, base 2, outer surfaces 3 of tower, cooling devices 5 with optional holes 6, and the cavity(s) 7 within the heatsink h, here having a battery 8 inside. With this embodiment however, there exists a thermally and or electrically isolative material 19 that is provided between the inner wall of the tower 1 and/or base 2 and the battery 8 to provide thermal and optional electrical isolation between the heatsink h and the battery 8 (or whatever electrical device or devices are located within the cavity(s) 7).

FIG. 3 also more clearly shows a feature shown in FIG. 1 whereby individual light sources, such as LEDs 17, are mounted to a strip 18 which is mechanically and thermally connected to one or more of the outer surfaces 3 of heatsink tower 1. Electrical connection 11 to and/or from light sources 18 or any other electrical devices in the vicinity, may again be made via holes 10 in base 2.

Holes 21 may be present in the underside of the base 2 for mechanically attaching the heatsink h to another component of the lamp, such as an electrically and thermally isolative base section of a lamp, as schematically illustrated in FIG. 4.

The embodiment shown in FIG. 4 schematically illustrates how the heatsink h can be mounted in a light bulb, in this instance in the form of a traditional “look alike” light bulb having a plurality of LEDs 17 as the light source(s) in strips 18, and in which the LEDs 17 may provide illumination using power from either an external supply through fitting 25 (such as from a mains supply or external battery) and/or via the internal battery 8.

For example, the electronic circuitry mounted on circuit boards 24 may be configured to detect when the light bulb is connected to a light fitting and arranged to receive mains power when a switch is closed; to detect loss of mains power when the switch is still closed (indicative of a power cut) and in response, to connect the battery 8 to the light sources 4 so that emergency lighting is provided. The electronic circuitry 14 can distinguish between a power failure and the light being “switched off” by a user, by monitoring or measuring the resistance or impedance between the normal electrical contacts of the light bulb—when the user opens the switch, the monitored or measured impedance will increase significantly. More details of the way this can be achieved is described in the above mentioned GB patent number 2447495, the content of which is hereby incorporated by reference.

In this embodiment, the heatsink base 2 additionally forms the main chassis for the light bulb, having many manufacturing assembly advantages. The groove 13 in base 2 (shown more clearly in FIG. 1) is used in this embodiment to mechanically support a light transparent or translucent globe 22 of any design or shape; and which may form a sealed enclosure of all parts within and above base 2. In this embodiment, below base 2 an isolative enclosure 23 is provided which may house all or part of the electronic circuitry 14 or additional electronic circuitry or printed circuit boards. The light bulb also has a fitting cap 25 for mechanically and or electrically attached the light bulb to an external fitting.

In conclusion, generally describing the light bulb example shown in FIG. 4, the light source can be any technology. In the design shown multiple LEDs 17 are spread inside globe 22 so as to provide a wide angle of illumination from the array. To achieve optimum efficacy and lifespan, LED array strips 18 are mechanically fixed and thermally connected to heatsink tower 1 which ensures lower component operating temperatures and hence longer LED life spans. Within the heatsink h a cavity 7 is provided for housing a battery 8 which may be of any type or technology such as lithium ion or any charge storage device that can provide power to illuminate the LEDs such as in the event of mains failure. This novel arrangement ensures optimum efficiency and reduces the space requirements for the lamp.

FIG. 5 illustrates an alternative arrangement for the fitting cap 25. With this design, the fitting cap 25 (which may have one or more parts) can additionally be thermally connected to the heatsink tower 1 through the base 2 so as to provide an external thermal conduction connection for primary or supplementary cooling when the fitting cap 25 is coupled into a receptacle fitting 27 such as that shown in FIG. 5. The receptacle fitting 27 may comprise any thermally conductive material to allow heat conduction and dispersal, which may be aided by cooling fins 28 or similar devices to increase radiator surface areas. The receptacle fitting 27 may be made up of more than one part, or a single structure in the case of a monolithic embodiment wherein 27 and 28 are the same extrusion.

The thermal connection can be integral to the mechanical fixing and or an electrical connection, thereby allowing heat transfer away from the heatsink h through the light fitting in order to minimise the overall size and cost of heatsink h and/or cooling elements 5 required within the base 2 of the heatsink.

Fitting cap 25, together with its mating receptacle 27, may be of any type, size, shape or design. By way of an example, in the embodiment illustrated in FIG. 5, the mechanical connection is provided by a bayonet cap featuring interlocking lugs 30 in fitting cap 25 and recess 31 for those lugs 30 in receptacle 27. Also illustrated in this FIG. 5, purely by way of an example, is the electrical connection(s) 32 from the printed circuit board(s) 24 to terminals 33 in the fitting cap 25 which, when mated with the receptacle 27, provide an electrical connection to lines 34 for receiving mains power.

As with FIG. 2, an electrically insulating layer 19 is provided on the inner wall of the cavity 7 to electrically insulate (predominately for safety purposes) the battery 8 and the electronic circuitry on circuit board 24 from the heatsink h. As illustrated in FIG. 5, the insulator layer 19, in this example embodiment, encloses the battery 8 within the cavity 7.

FIG. 6 illustrates (in cross section) a further embodiment of the heatsink h. In this case, the heatsink h is designed for use in an elongate light tube, in this instance utilising a plurality of LEDs 17 as the light source(s) in strips 18, wherein the light source(s) 17 may provide illumination using power from either an external source such as from a mains supply or an external battery, and/or via an internal battery 8. As illustrated in FIG. 6, the battery(s) 8 is/are partially or fully located within one or more cavities 7 within the heatsink h, to which the light source(s) may be adhered, directly or indirectly through strip(s) 18.

As illustrated in FIG. 6, one or more cooling devices 36 (such as cooling fins) may be provided that are attached to or integrally formed with the main body 35 of the heatsink h at different points along the length of the body 35. As with the other embodiments described above, the cavity 7 (or another cavity in the heatsink h) can additionally be used to fully or partially house other electronic circuitry or electrical components, such as printed circuit boards.

The above described lighting device can be used on its own and can also be used together with other lighting devices. For example, the device described above could be provided as an in-line adapter that plugs into a conventional light fitting and which has an attachment for allowing a conventional light bulb to connect to it and receive mains power from the light fitting. In the event of the mains failure, then the in-line adapter would switch on its emergency lighting powered by the local battery.

We have described above, a thermally conductive heatsink for cooling a plurality of light emitters within a lamp, luminaire, lighting device or ancillary apparatus thereof, the heatsink having one or more holes, recesses, compartments, chambers or internal cavities for locating one or more cells, batteries or other charge storage devices able to provide power to electronic control circuitry and or light source(s). The internal cavities may additionally provide space to fully or partially locate electronic circuitry or electrical components. Conjointly to thermal operation, the heatsink may act as a chassis or holder for one or more components of the lamp, luminaire or lighting device. The cooling elements can be of any size, design or material, and the heatsink can have one or more parts each of any shape, design, construction or material.

In a further embodiment, the heatsink h may be electrically conductive and electrically connected to the circuitry 14 on the circuit board 24 mounted therein. This arrangement is particularly advantageous where, for example, the circuitry 14 includes communications circuitry for wirelessly communicating with a remote device (such as a remote user controlled switch or a user's computer device via an access point of the user's WiFi network) and the heatsink can act as an antenna for the communications circuitry 14. Signals transmitted to the circuitry 14 can, for example, be used to control the brightness of the light generated by the lighting device. As the circuitry 14 is able to detect when a mains failure occurs, the circuitry 14 may also be arranged to transmit this information to the remote device for data logging or other control purposes.

1.-29. (canceled)

30. A lighting device comprising:
a heatsink and one or more light sources mounted on an outer surface of the heatsink, wherein the heatsink comprises one or more internal cavities;
electrical connections for receiving power from an external supply;
a battery mounted within the cavity of the heatsink; and
circuitry for controlling power delivery to the one or more light sources using power from at least one of the battery and the external supply.

31. A lighting device according to claim 30, wherein the heatsink comprises means for providing an electrical isolation between the cavity and the outer surface on which the one or more light sources are mounted, wherein the means may be the wall of the heatsink or an insulating material if the heatsink is made of an electrically conductive material.

32. A lighting device according to claim 30 wherein a wall of the heatsink that defines one or more of the cavities comprises a thermally non-conductive material.

33. A lighting device according to claim 30, wherein the heatsink comprises an elongate tower portion and wherein one or more of said cavities is provided within said tower portion.

34. A lighting device according to claim 30, comprising a multi-faceted outer surface, each facet providing a mounting point for one or more light sources.

35. A lighting device according to claim 30, wherein the heatsink has a base portion with one or more cooling devices.

36. A lighting device according to claim 30, having a base portion with a groove into which a transparent or translucent cover can be fitted enclosing the portions of the heatsink carrying the one or more light sources.

37. A lighting device according to claim 30 wherein the heatsink is mounted internally or externally within a light bulb enclosure or other luminaries or ancillary lighting devices or equipment.

38. A lighting device according to claim 30, wherein said one or more light sources comprises one or more Light Emitting Diodes (LEDs), Organic LEDs, or other heat-producing light emitting devices.

39. A lighting device according to claim 38, wherein said heatsink is multifaceted and wherein one or more of said LEDs are mounted on a plurality of facets of the heatsink.

40. A lighting device according to claim 39, wherein said LEDs are mounted in a linear array on each of the plurality of facets of the heatsink.

41. A lighting device according to claim 30, wherein said one or more light sources are thermally attached to one or more flat or curved surfaces of the heatsink.

42. A lighting device according to claim 30, comprising a fan for directing an air flow over the heatsink.

43. A lighting device according to claim 30, comprising a translucent or transparent cover that encases the at least one light source.

44. A lighting device according to claim 43, wherein the cover encases an elongate portion of the heatsink comprising said cavity and sits within a groove provided on a base of the heatsink.

45. A lighting device according to claim 43, wherein the cover is bulb shaped or tube shaped.

46. A lighting device according to claim 30, wherein the lighting device comprises electronic circuitry configured to distinguish between removal of a mains supply to the lighting device by a user opening a switch coupled, in use, to the lighting device and mains failure; and, upon detection of the mains failure, configured to couple said battery to the light sources to provide emergency lighting functionality.

47. A lighting device according to claim 30, wherein the device is an in-line adapter having a connector for connecting to a light fitting and an adapter for receiving a light bulb or other lighting device.

48. A lighting device according to claim 30, wherein the heatsink is electrically conductive and is electrically connected to circuitry of the lighting device.

49. A lighting device according to claim 48, wherein the circuitry comprises communications circuitry for communicating with a remote device and wherein the heatsink is arranged to act as an antenna for the communications circuitry.

50. A lighting device according to claim 49, wherein the communications circuitry is operable to receive commands from the remote device and is operable to control the light generated by the lighting device in dependence upon the received commands.

51. A lighting device according to claim 30, wherein the circuitry is mounted within a cavity of the heatsink.

52. A method of making a lighting device comprising the steps of:
providing a heatsink having an internal cavity;
mounting one or more light sources on an outer surface of the heatsink;
providing electrical connections for receiving power from an external supply;
mounting a battery within the cavity of the heatsink; and
providing circuitry for controlling power delivery to the one or more light sources using power from at least one of the battery and the external supply.
